(19) United States
(12) Patent Application Publication
(10) Pub. No.: US 2025/0304362 A1
(43) Pub. Date: Oct. 2, 2025

(54) MODULAR DECK SYSTEM FOR USE WITH MOBILE PLATFORMS

(71) Applicant: Innovative Logistics, LLC, Fort Smith, AR (US)

(72) Inventors: Brandon Levi Loukota, Greenwood, AR (US); William Conrad Jones, Greenwood, AR (US); Dylan Henderson, Fort Smith, AR (US); Tyrel James Bryan, Fort Smith, AR (US); David George Albers, Jr., Fort Smith, AR (US); Jefferson Maldonado, Fort Smith, AR (US); Daniel Crober, Fort Smith, AR (US); Brock Mcallister, Fort Smith, AR (US); Kenneth Noblitt, Fort Smith, AR (US)

(21) Appl. No.: 19/095,870

(22) Filed: Mar. 31, 2025

Related U.S. Application Data
(60) Provisional application No. 63/572,524, filed on Apr. 1, 2024.

(51) Int. Cl. B65D 90/00

(52) U.S. Cl. CPC B65D 90/0073

(57) ABSTRACT

Disclosed herein is a modular deck system for use with a mobile platform. The modular deck system comprises a plurality of vertical posts with engagement members coupled to the mobile platform for receiving modular decks placed on the vertical posts. The modular decks may be placed and secured at different heights as needed by the. The modular decks, filled with freight, may be placed onto the vertical posts at a plurality of different predetermined heights on one or more sections of the mobile platform.

### CROSS-REFERENCE TO RELATED APPLICATIONS

This application claims priority to U.S. Provisional Application Ser. No. 63/572,524, filed Apr. 1, 2024, the entire contents of which are hereby incorporated by reference in their entirety.

### FIELD OF INVENTION

The present invention is directed to vertical posts and modular decks for use with mobile platforms (MP) or in a warehouse environment.

### BACKGROUND

The trucking industry, specifically the segment consisting of Full-Truckload (FTL) and Less-than-truckload (LTL), ships a wide array of freight. The shipment sizes can vary from an individual item consisting of one piece to a full truckload consisting of several pieces. FTL freight is typically handled only once as it is loaded into a semi-trailer at the shipper's location and unloaded at the consignee's location. In the LTL industry, freight is commonly handled multiple times, with the shipper loading the freight into a semi-trailer, then the freight is returned to a local freight terminal to be unloaded/loaded into another trailer to be routed to the destination. This process, commonly known as a hub-and-spoke network, is used to increase the efficiency of the operation by increasing density.

The traditional method of loading freight into a semi-trailer is to back a semi-trailer to a raised dock and load each piece/pallet using a forklift. A 53′ semi-trailer van can hold up to 30 pallets on the floor of the trailer. To unload a loaded semi-trailer conventionally, it requires a single forklift driver to drive into the trailer to pick-up and remove each pallet. During this unloading process, a driver could take up to 30 trips into the trailer to remove each pallet. This process is typically completed utilizing 1 forklift driver, but it is possible to utilize 2 forklift drivers to unload a trailer simultaneously.

As should be apparent, this process is wasteful in that the forklift is often not conveying cargo (empty carries). Also, because the trailer is not connected to the dock, the forklift driver must be careful each time that they enter and exit the trailer. This further reduces the speed of the process. Therefore, there is clearly a need for a more efficient platform which can be used to easily remove freight from a trailer.

Further, in cross-dock operations, there is generally no easy way to modify or stack pallets or freight. This can lead to a great deal of unused capacity in a trailer. Accordingly, the present invention provides a modular system enabling the easy stacking and bulk movement of freight not previously realized.

### SUMMARY

The present invention discloses a modular deck system for use with a mobile platform. The modular deck system comprises a plurality of vertical posts with engagement members coupled to the mobile platform for receiving modular decks placed on the vertical posts. The modular decks, filled with freight, may be placed onto the vertical posts at a plurality of different predetermined heights on one or more sections of the mobile platform.

### BRIEF DESCRIPTION OF THE DRAWINGS

FIG. 1 depicts a perspective view of the primary components of the modular deck system coupled to a mobile platform according to an embodiment of the invention.

FIG. 2 depicts the engagement between a vertical post and a corner of a deck according to an embodiment of the invention.

FIGS. 3-5 depict views of an engagement member in isolation according to an embodiment of the invention.

FIGS. 6 and 7 depict views of a vertical post in isolation according to an embodiment of the invention.

FIG. 8. depicts an end securement bracket coupled to an exterior of a vertical post according to an embodiment of the invention.

FIG. 9 depicts a coupling pin inserted through a securement opening of a post mounting bracket according to an embodiment of the invention.

FIG. 10 depicts an exploded view of a vertical post according to an embodiment of the invention.

FIG. 11 depicts the inside spacing between adjacent vertical posts according to an embodiment of the invention.

FIGS. 12 and 13 depict the steps utilized to engage an engagement member with a table slot 206 according to an embodiment of the invention.

FIG. 14 depicts the connection between an engagement member and a deck according to an embodiment of the invention.

FIG. 15 depicts one or more securement beams installed on a securement face of a vertical post according to an embodiment of the invention.

FIG. 16 depicts a deck installation funnel for assisting with the initial installation of a deck onto a vertical post.

FIGS. 17 and 18 depict a deck installation funnel in isolation according to an embodiment of the invention.

FIG. 19 depicts a height indicator installed on a vertical post according to an embodiment of the invention.

FIG. 20 depicts an end securement bracket in isolation according to an embodiment of the invention.

FIGS. 21 and 22 depict alternate embodiments for vertical posts according to an embodiment of the invention.

FIGS. 23-25 depict an embodiment of engagement members having securement posts inserted into securement beam mounts according to an embodiment of the invention.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

The embodiments disclosed herein are for the purpose of providing a description of the present subject matter, and it is understood that the subject matter may be embodied in various other forms and combinations not shown in detail. Therefore, specific embodiments and features disclosed herein are not to be interpreted as limiting the subject matter as defined in the accompanying claims.

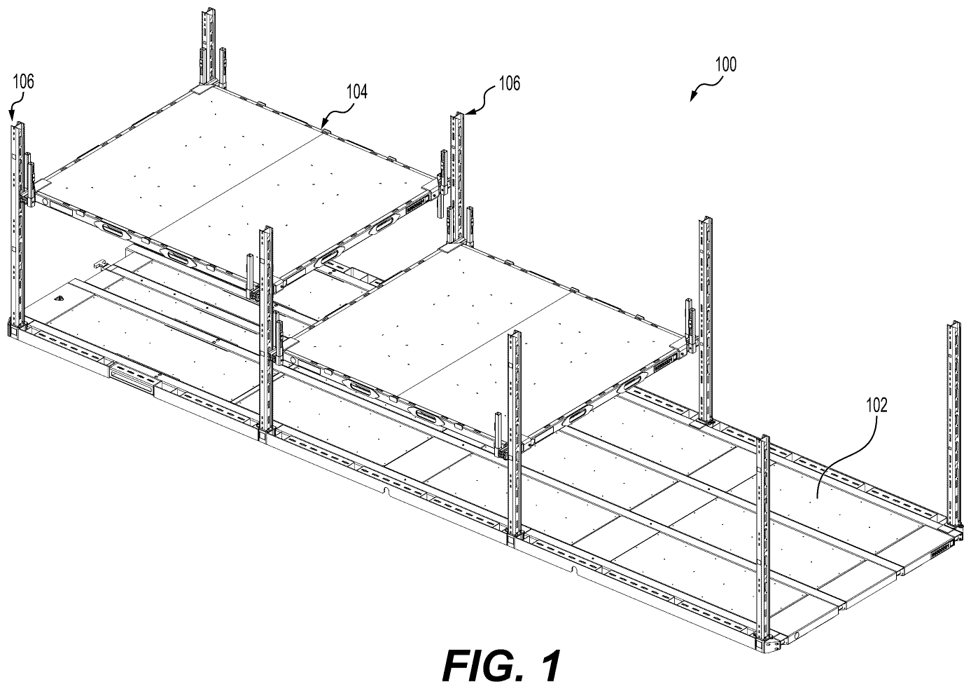

Referring first to FIG. 1, depicted are the principal components of the modular deck system 100. As shown, modular deck system 100 generally comprises MP 102, decks 104, and vertical posts 106. The decks 104 can be placed on the vertical posts 106 at a plurality of predetermined heights as will be explained later.

The length and width of MP 102 are preferably such that MP 102 is easily accommodated within a standard pup trailer. In a preferred embodiment, the length of MP 102 is 26′ and the width of MP 102 is 8′. However, it should be apparent that the length and width of MP 102 can be varied to accommodate any trailer dimensions.

Vertical posts 106 are preferably equally spaced along the length of MP 102 in pairs. This allows all decks 104 to be made a standard rectangular or square size which reduces manufacturing costs. However, it should be apparent that the distance between pairs of vertical posts 106 can be varied. This modification would require that the decks 104 be manufactured in different widths and lengths. The spacing of vertical posts 106 would also be modified to accommodate the different shaped decks 104.

The vertical posts 106 located at the ends of MP 102 are preferably set back from the end of MP 102 by at least a width of the engagement members 202 (e.g., 4″) to allow for easier loading of MP 102 into a trailer. However, it should be apparent that vertical posts 106 may also be located at an edge of MP 102. In such an embodiment, it may be desirable to only have engagement members 202 located along inner edges of vertical posts 106 along MP 102.

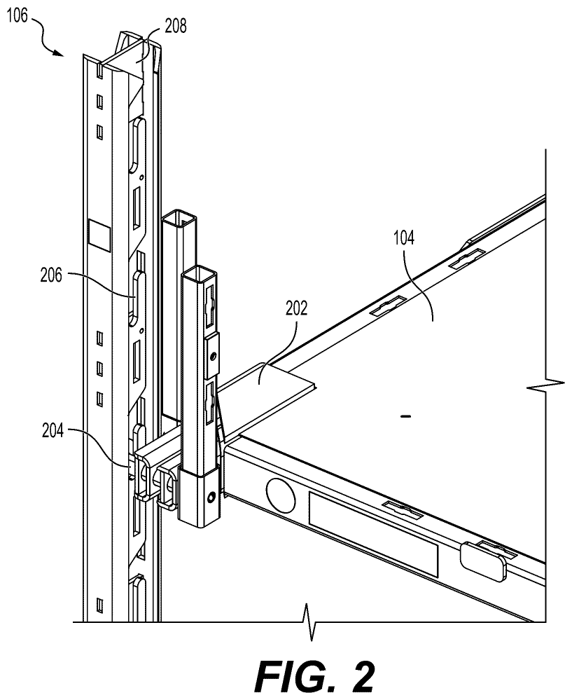

FIG. 2 depicts the engagement between a single vertical post 106 and a corner of a deck 104. In a preferred embodiment, the engagement is similar for all four corners of deck 104, but it should be obvious to one of ordinary skill in the art that other engagement techniques could also be utilized. Each corner of deck 104 comprises engagement member 202 which is detachably coupled to deck 104. The engagement member 202 comprises a table pin 204 which engages with a table slot 206 within post track 208.

### Engagement Member 202

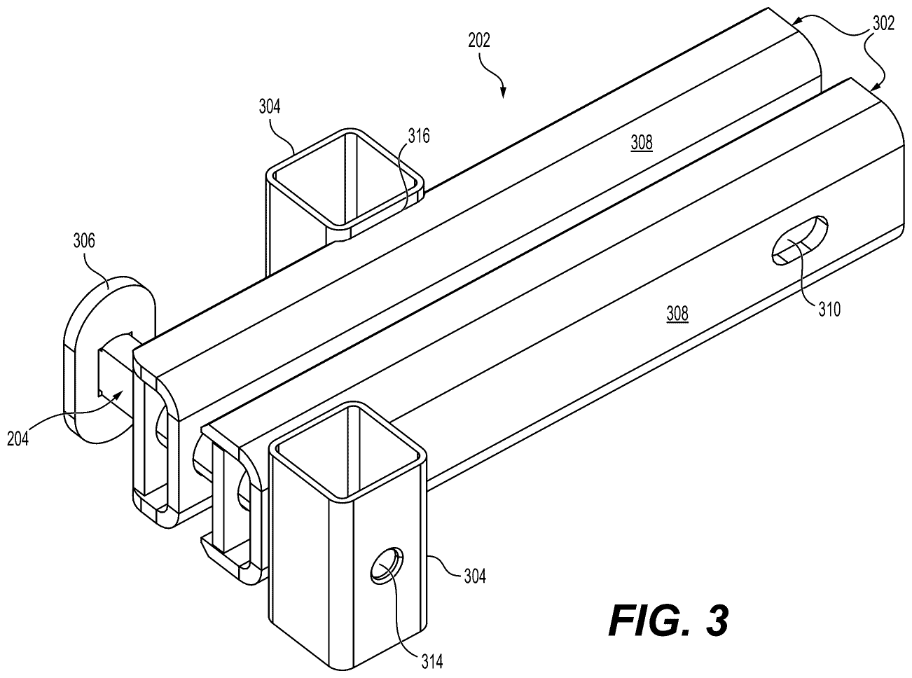

FIGS. 3-5 depict views of engagement member 202 in isolation. As shown, the engagement member generally comprises table pin 204, corner slides 302, and securement beam mounts 304. An end of each table pin 204 comprises retention washer 306 which has a width and a length greater than a main shaft of table pin 204. The retention washer 306 retains the table pin 204 within the post track 208 in which it is placed. Preferably, a bottom and a top of retention washer 306 do not extend beyond a top or bottom of deck 104 so that multiple decks 104 can be stacked for storage or transit without needing to remove engagement members 202.

Each engagement member 202 may further comprise one or more securement beam mounts 304 which provide a place to attach securement beams directly to the deck 104 instead of to the vertical posts 106. When a deck 104 is placed on vertical posts 106, the securement beam mounts 304 preferably do not extend beyond an outer edge of the vertical posts 106 to allow additional securement beams to be mounted to vertical posts 106 without interference.

Corner slides 302 attach to pocket openings on the corners of deck 104 and allow for limited movement of engagement member 202 with respect to deck 104 in at least one dimension to account for out-of-level table movement. The chamfered edges of corner slides 302 allow for fitment with the deck 104. The radius on the leading corner of each corner slide 302 prevents snagging while conveying into or out of a trailer or container.

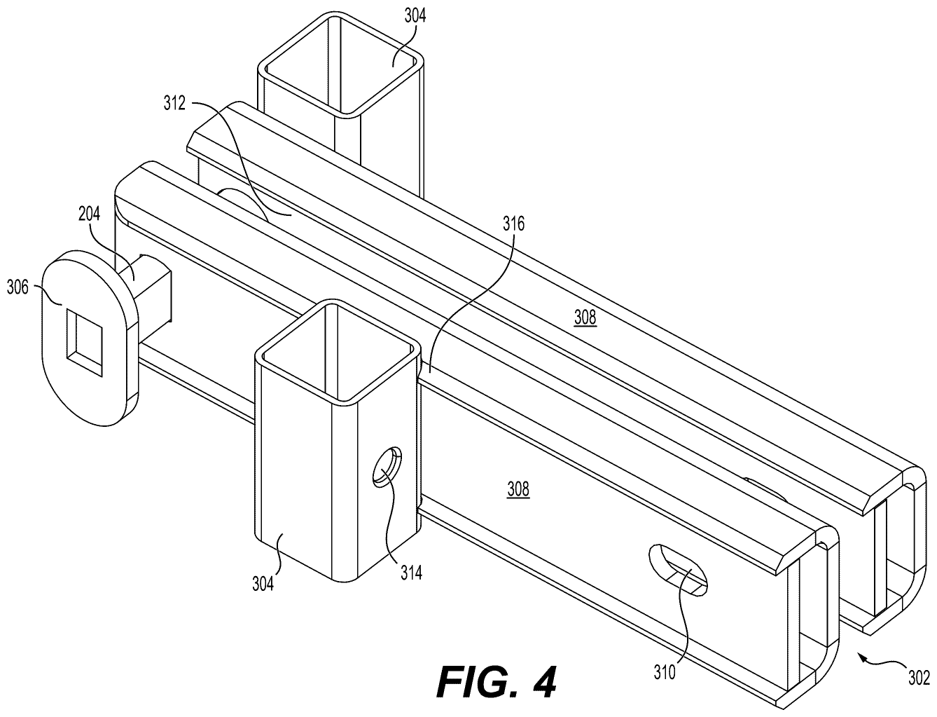

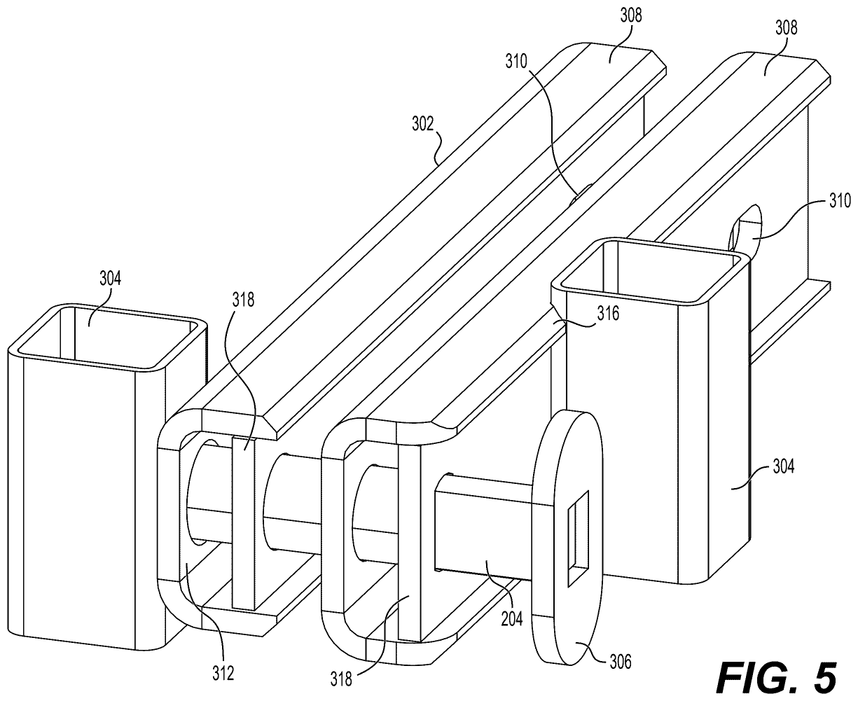

In a preferred embodiment, corner slides 302 comprise two beams 308 secured together at a first end by table pin 204. Table pin 204 preferably has a rectangular or square cross section to minimize rotation of beams 308 relative to each other and table pin 204. A rear end of table pin, opposite retention washer 306, is preferably secured to an interior surface 312 of a beam 308 as depicted in FIG. 4. As best depicted in FIG. 5, a small gap preferably exits between beams 308. The beams 308 are secured in position (e.g., via welding) to table pin 204 length as needed to accommodate for movement of deck 104 during transit.

Each beam 308 comprises a recessed plate 318 to allow clearance for internal weld seam. Weld seam orientation of the 202 Engagement member tubes are preferably present on the inside face of the beams 308 closest to the centerline of the deck 104.

Engagement member 202 is secured to deck 104 by a pin (removable) placed through obround openings 310 at a second end of beams 308 as will be shown later. The pin used to secure the engagement member has a diameter that is less than a length of the obround openings 310, allowing the engagement member 202 limited horizontal movement with respect to deck 104 when secured.

Securement beam mounts 304 may be welded to beams 308 or secured using fasteners, such as bolts. In some embodiments, beam 308 may comprise cutout 316 to accommodate a securement beam mount 304. Each securement beam mount 304 has one or more openings 314 to engage securement beams for deck 104. Opposing ends of a securement beam may be inserted into openings 314 to provide additional securement as needed. Alternatively, openings 314 may be utilized to secure additional vertical beams placed vertically into the top opening of securement beam mounts 304.

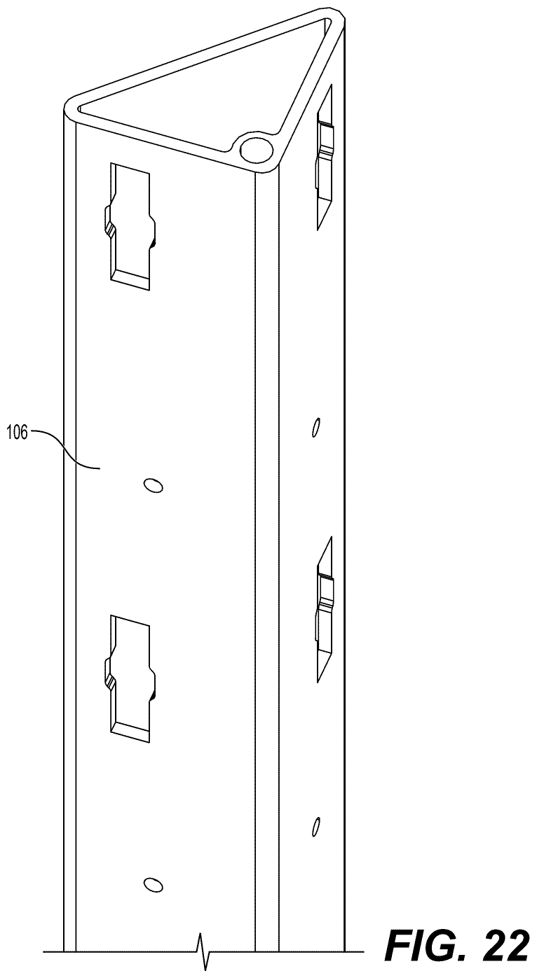

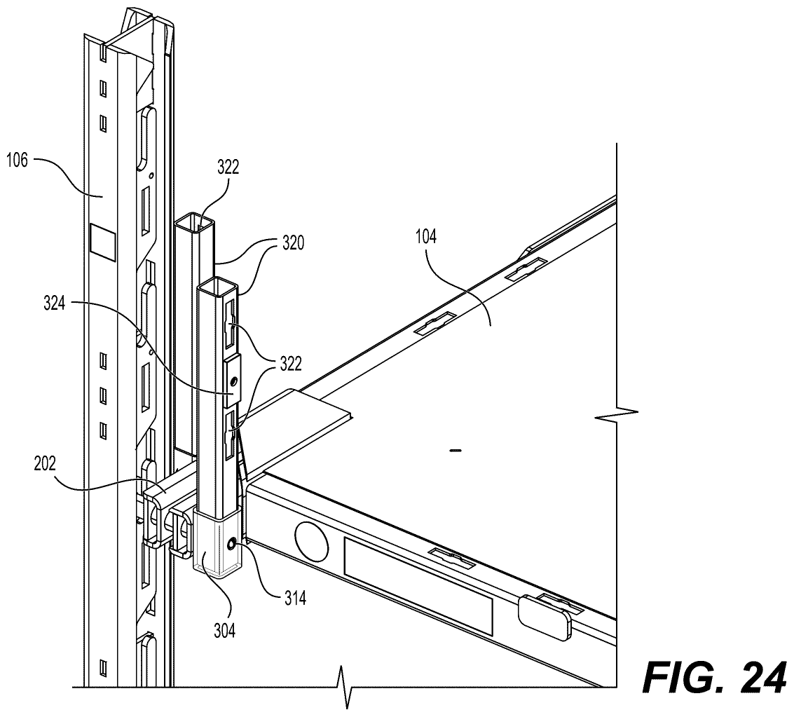

The securement beam mounts 304 may be utilized to secure freight that is loaded on the top of the deck 104. This removes the need to have additional structure that is added to the vertical posts 106, which can create snag points during conveyance in and out of a trailer or door. As depicted in FIGS. 22-24, the vertical extensions 320 may have a spring-loaded button that can extend through opening 314 to secure them within securement beam mount 304 without tools. Vertical extensions 320 are easily replaceable if damaged and can be flipped upside down in 304 during loading/unloading of the deck 104 if needed. An optional magnet 324 is shown that can be used for storage when not in use to store out of the way to any steel structure. These have E-track cutouts so beams and/or strap can be utilized.

### Vertical Post 106

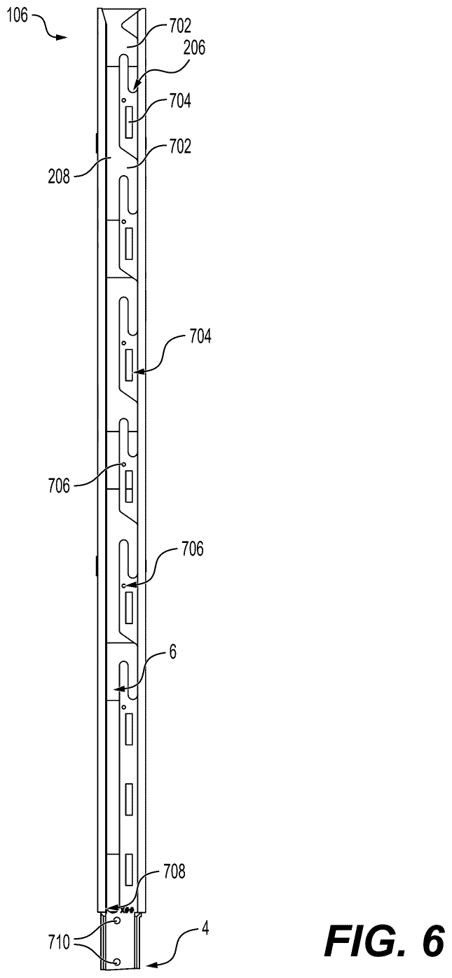

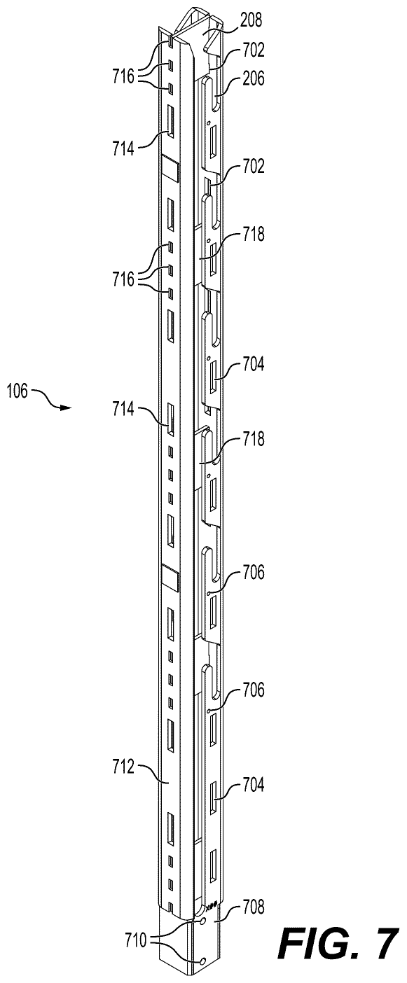

FIGS. 6 and 7 depict a vertical post 106 in isolation. In a preferred embodiment, each vertical post 106 has the same construction. However, it should be apparent to one of ordinary skill in the art that the vertical posts 106 can have different heights, number of openings, etc.

A first side of vertical post 106 comprises post track 208 having a plurality of table slots 206 adjacent the post track 208 for accommodating table pin 204. The depicted vertical post 106 comprises a total of six table slots 206 on opposing sides of vertical post 106 on which deck 104 rests. To install a deck 104 onto a grouping of four vertical posts 106, the deck is first lifted above a top of vertical posts 106 and it is lowered until the table pin 204 engages the post track 208. The retention washer 306 is located within an interior of post track 208 and prevents disengagement of the engagement member 202 from vertical post 106 unless deck 104 is lifted above the top of the vertical posts 106. The deck 104 can be raised or lowered by maintaining the table pin 204 on a first side of the post track 208 (e.g., on the left side in the depicted embodiment). Once the desired table slot 206 has been reached, the table pin 204 is shifted to the other side of the post track 208 (to the right side in the depicted embodiment) and the deck 104 is lowered until the table pin 204 contacts a bottom of table slot 206. The deck 104 can be removed or changed to a different table slot 206 by again moving the table pin 204 outside the table slot 206 into the post track 208 on all four vertical posts 106.

Vertical posts 106 can be constructed in a variety of ways. Custom 3″×3.75″ tubing can be used; the process for this is to cut out the main profile from a single piece of the tube, but leave connecting tabs. Next, the bracing plates are welded to reinforce the two sides. Then the tabs are cut free.

If 3″×3.75″ is not available due to time or cost constraints, the alternate construction method is to use 3″×4″ tubing available off the shelf. This method requires the tubing to be cut completely in two after the features are cut, then using a fixture, the two can be rejoined by welding in the bracing plates. This separating and rejoining allow the tube to be welded back together ¼ smaller and meet the specified dimensions. Spine Plate 718 allows assembly to be cut from a tube that is narrower than the finished post and eliminate the wasted material of the continuous post track 208. This separating and rejoining allow the tube to be welded back together ¼ smaller and meet the specified dimensions.

The top of each table slot 206 preferably has angled opening 702 that is wider at the top to allow for easier maneuvering of table pin 204 into table slot 206. The bottom portion of each table slot 206 has a width approximately the same width as the table pin 204 to minimize movement of deck 104 and to provide rigidity.

A securement beam slot 704 may be formed below each table slot 206. Further, securement beam slots 704 may be formed independent of the table slots 206 such as the two depicted securement beam slots 704 near a bottom of vertical post 106. Similar to securement beam mounts 304, the securement beam slots 704 may be utilized to accommodate the ends of a securement beam placed between two vertical posts 106.

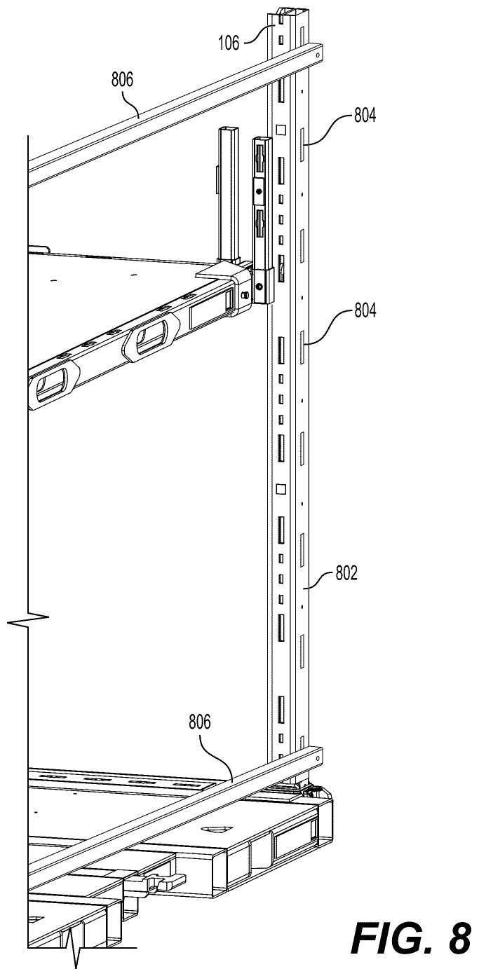

Each vertical post 106 may further comprise a plurality of end securement bracket mounts 706 for attaching a removable end securement bracket 802 which can cover a portion of an exterior of the vertical post 106 or an entire side. FIG. 8 depicts an example end securement bracket 802 coupled to an exterior of vertical post 106. The end securement bracket is preferably formed from aluminum and has a plurality of securement beam openings 804 (that may align with post track 208). In some embodiments, the securement beam openings 804 have a standard sized opening to accommodate standardized securement beams 806. This allows securement beams 806 to be installed past an edge of the vertical post 106 as depicted in FIG. 8. However, since end securement bracket 802 is removable, different of end securement brackets 802 with any sized or number of securement beam locations 804 can be manufactured and attached to vertical posts 106 as required.

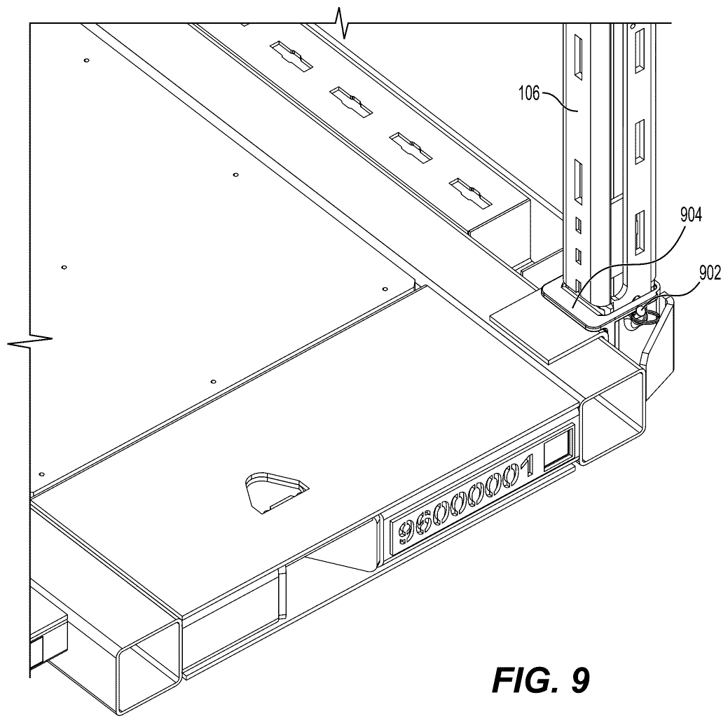

A bottom of each vertical post 106 comprises an angled bottom 708 to ensure that vertical posts 106 slightly lean and are biased towards a center of MP 102 to reduce equipment damage. Vertical post 106 may comprise one or more securement openings 710 for releasbly securing vertical post 106 to MP 102. As shown in FIG. 9, a coupling pin 902 is inserted through a post mounting bracket 904 of MP 102 into one or more of the securement openings 708. The bottom of vertical post 106 is inset to allow for pinwheeling of standard 40″×48″ pallets between vertical posts 106. The angled bottom of vertical post 106 assists in the installation of decks 104. The bias towards the center of the MP 102 ensures that the top of the vertical post 106 is within a known/consistent location to align with retention washer 306 on the corner 308. The bias inward also reduces the possibility of snagging when conveying in/out of a trailer/door in securement only configurations (no tables).

Referring back to FIG. 7, a securement face 712 of vertical post 106, orthogonal to the sides comprising the post tracks 208, may comprise a plurality of openings 714 for accommodating different securement types such as securement beams, tie downs, securement straps, etc. The securement face 712 further comprises bracing plate openings 716 used for securing bracing plates 718 used to couple a first side of vertical post 106 to a second side of vertical post 106.

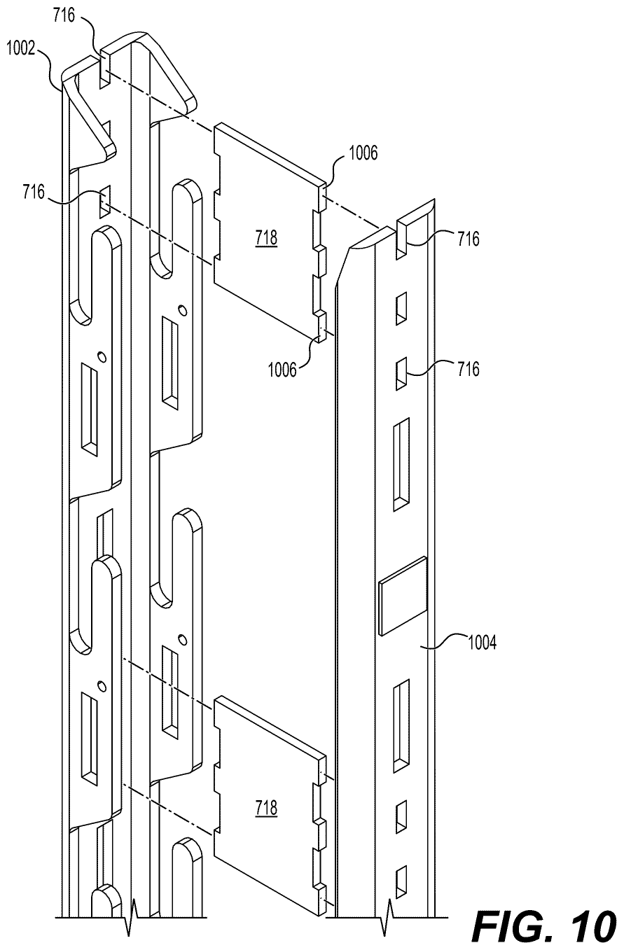

FIG. 10 depicts an exploded view of vertical post 106. Vertical post 106 is comprised of track section 1002 and securement section 1004 in some embodiments. A plurality of aligned bracing plate openings 716 are formed on track section 1002 and securement section 1004. Each bracing plate 718 has a plurality of teeth 1006 on opposing sides for joining track section 1002 and securement section 1004. In the depicted embodiment, a total of five bracing plates 718 having three teeth 1006 on each side are utilized. However, it should be apparent to one of ordinary skill in the art that the number of bracing plates 718 and teeth 1006 can be varied as required. The bracing plates and teeth 1006 are preferably placed within the brace plate openings 716 and welded in position to provide structural stability.

The use of bracing plates 718 allows for increased stiffness while reducing the overall weight of vertical post 106 as compared to a similar beam or truss construction. Further, track section 1002 and securement section 1004 can be cut from sheet metal and then bent into the appropriate shape before joining. This allows for a less expensive construction as compared to a beam having cutouts.

Tube laser cutting is the cost-effective option better suited for large quantities but flat laser bent sections or plate/tube machining is possible as well. With any cutting process, the preferred internal weld seam location of the post is the face furthest from the center line of the platform to avoid interference with the corner assembly or E track securement positions.

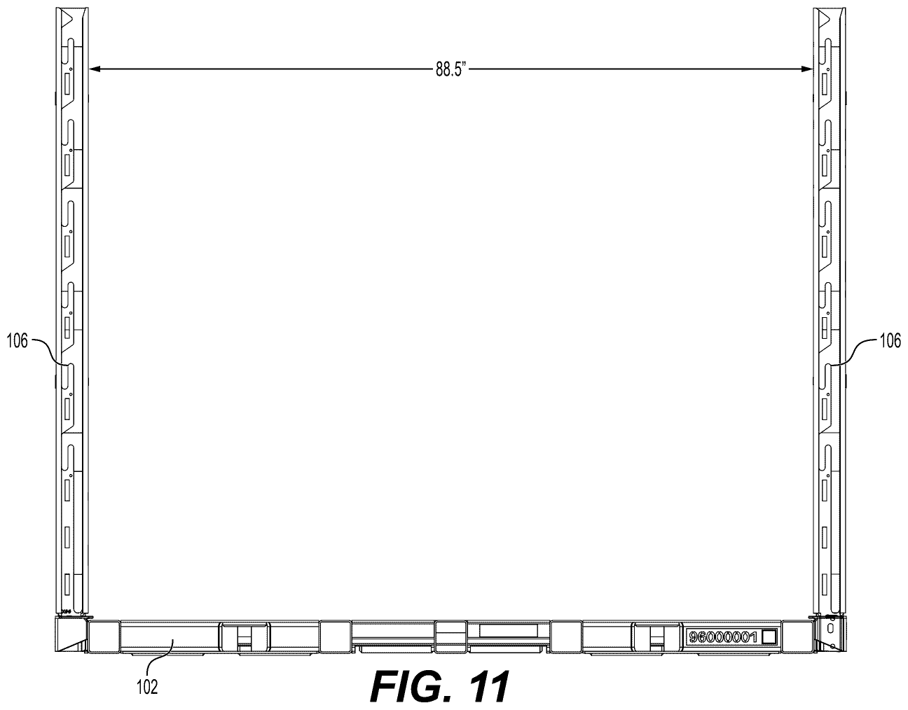

FIG. 11 depicts the inside spacing between adjacent vertical posts 106 on MP 102. The depicted inside spacing is 88.5″ which allows for pinwheeling pallets, that is, placing one 40″×48″ pallet longways and the second short ways, continuing down the MP 102.

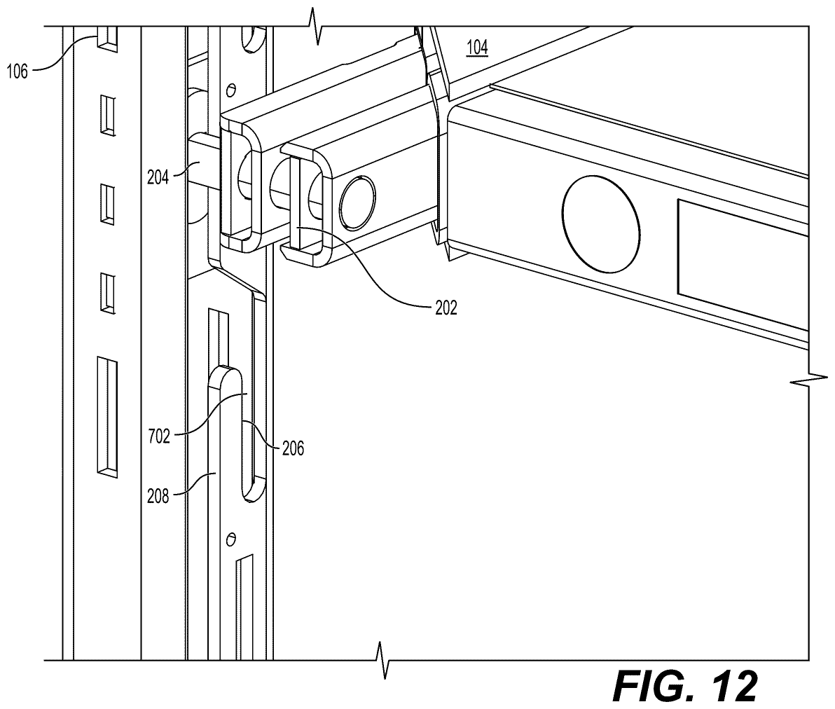

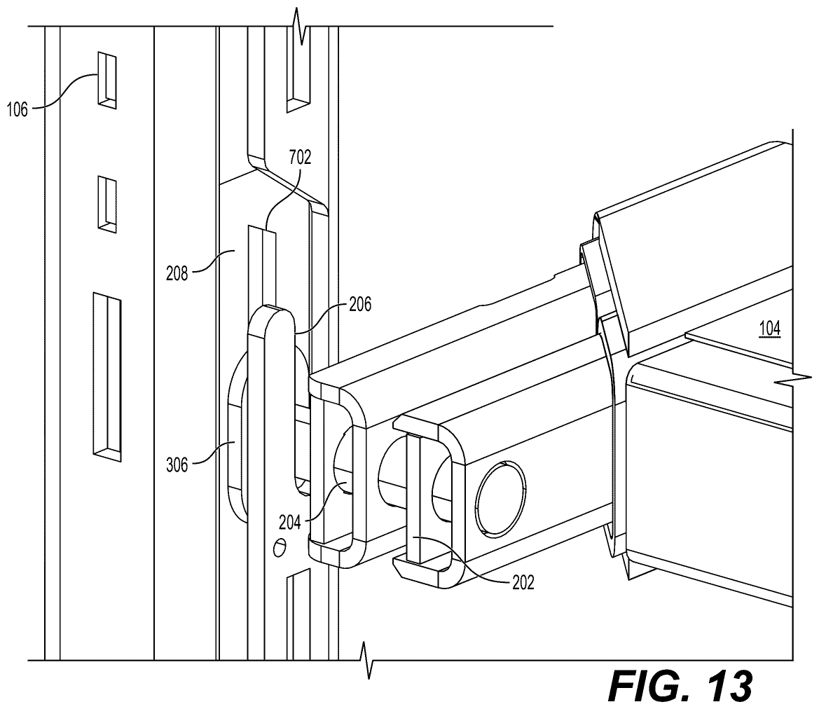

FIGS. 12 and 13 depict the steps utilized to engage engagement member 202 with table slot 206. First, the deck 104 is moved upwards or downwards until it is next to the angled opening 702 above the desired table slot 206 as depicted in FIG. 12. The deck 104 is then shifted so that table pin 204 is directly above table slot 206. The deck 104 can then be lowered to engage table slot 206 as depicted in FIG. 13. Retention washer 306 ensures that table pin 204 cannot leave post track 208, angled opening 702, or table slot 206.

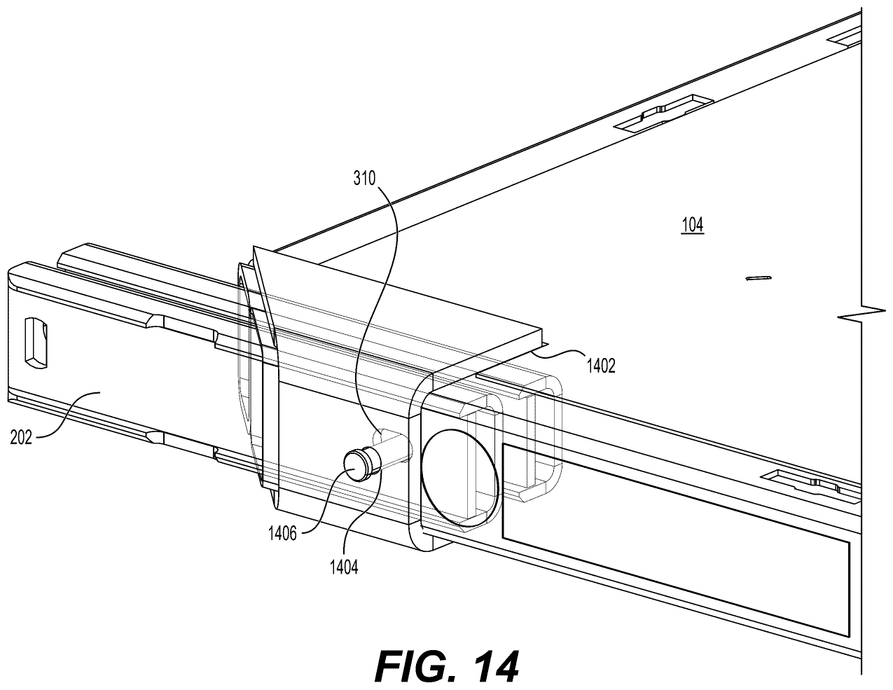

FIG. 14 depicts the connection between the engagement member 202 and the deck 104 according to an embodiment of the invention. The beams 308 of the engagement member 202 are inserted into a pocket 1402 sized to accommodate the ends of the beams. The pocket 1402 has openings 1404 on both sides. Unlike obround openings 310, the diameter of the pin 1406 is approximately the same diameter as openings 1404. The pin 1406 is inserted through both openings 1404 in pocket 1402 (on opposing sides of pocket 1402) and obround openings 310 to secure the engagement member 202. Because the obround openings 310 are wider than the pin 1406, the engagement member 202 can move back and forth in one dimension to accommodate limited movement of the deck 104 with respect to engagement member 202. The movement is limited by the width of the obround channel 310 and can be enlarged or reduced if required.

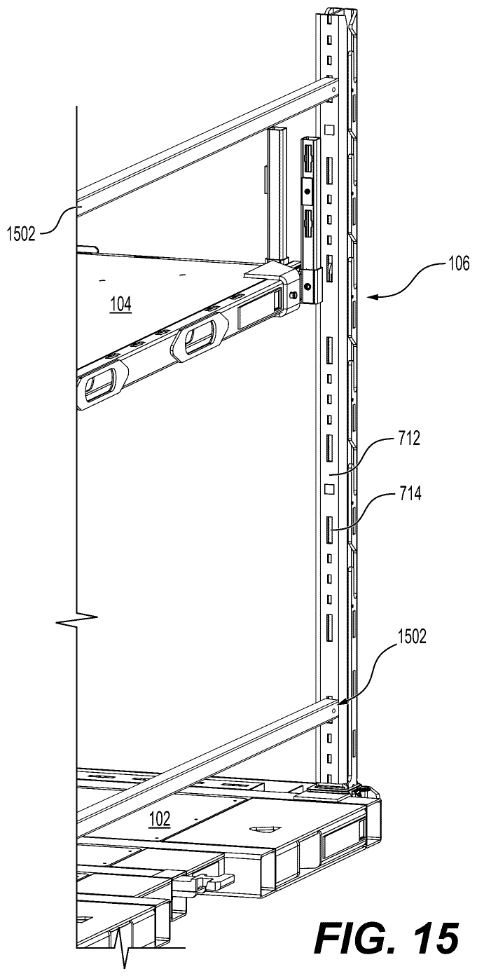

FIG. 15 depicts how one or more securement beams 1502 can be installed on securement face 712 of a vertical post 106. An operator is free to adjust deck 104 upwards or downwards even with securement beams 1502 installed.

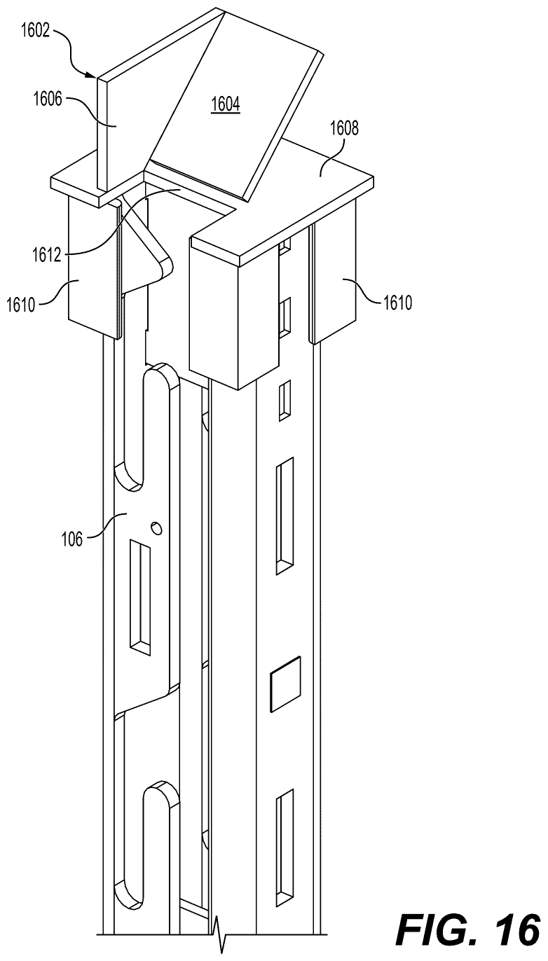

FIG. 16 depicts a deck installation funnel 1602 which can be used to assist with the initial installation of a deck 104 onto a vertical post 106. As previously described, the initial installation of deck 104 requires the operator to lower each table pin 302 into post rack 208 so that retention washer 306 is located within an interior of vertical post 106 to prevent disengagement. Deck installation funnel 1602 effectively increases the operating tolerances for the operator during deck installation. As long as the operator can position retention washer 306 above ramp surface 1604, the table pin 302 will be guided into post track 208 as deck 104 is lowered.

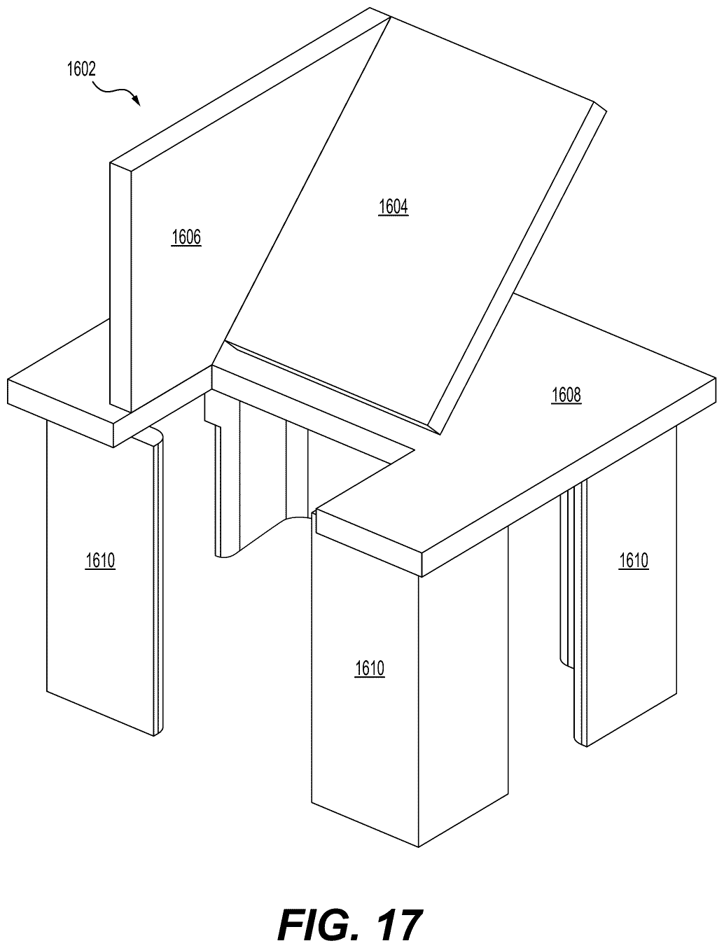

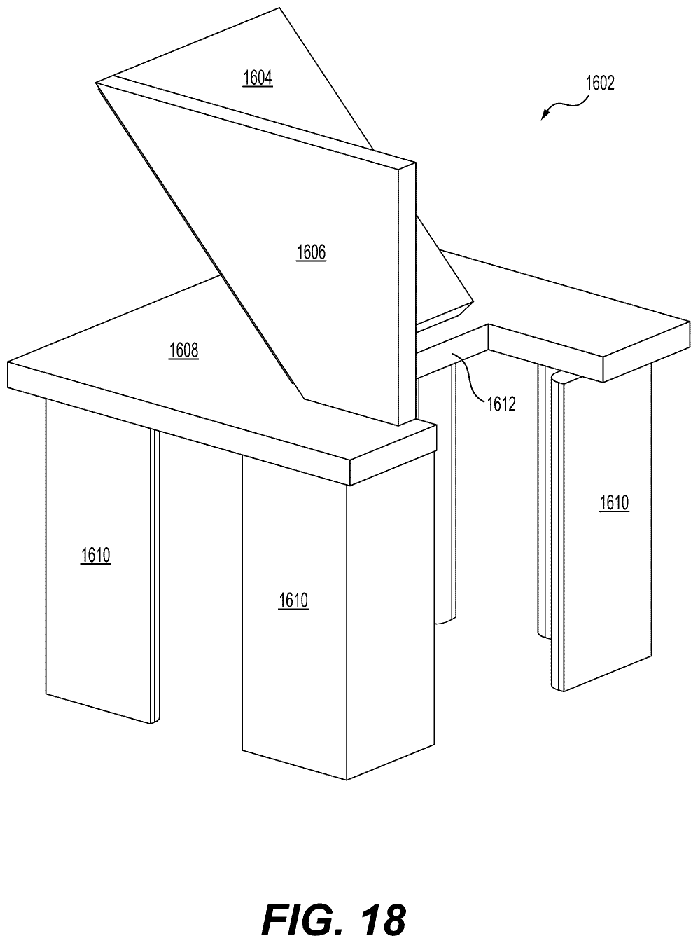

FIGS. 17 and 18 depict deck installation funnel 1602 in isolation. Deck installation funnel 1602 generally comprises ramp surface 1604, guide surface 1606, base cap 1608, and feet 1610. Four feet 1610 are coupled to base cap 1608 and extend downward from a bottom of base cap 1608. The feet 1610 are generally L-shaped and are arranged so that they cap the top of a vertical post 106 when the deck installation funnel 1602 is placed as shown in FIG. 16. The base cap 1608 include notch 1612 which has a size approximately the same width and length of post track 208. The operator may initially contact the guide surface 1606 with a side of retention washer 1306 so that it may be used as a guide for further positioning.

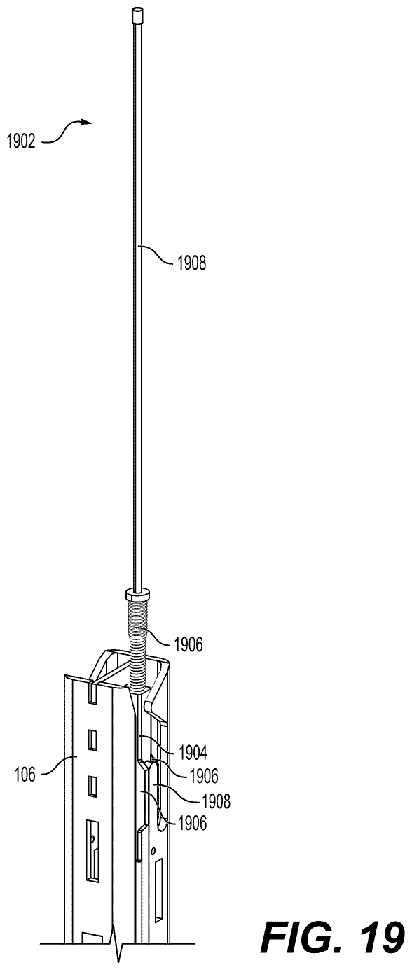

FIG. 19 depicts a height indicator 1902 installed on a vertical post 106. Height indicator 1902 generally comprises base 1904, spring connection 1906, and indicator 1908. The base 1904 may be adapted to be installed in a pocket or engagement member of an end securement beam 802. Alternatively, base 1904 can be configured to mate with one or more features of the vertical post 106. The spring connection 1906 allows the indicator 1908 to deflect and protects equipment and freight against incidental contact. The indicator 1908 has a length such that a top of the indicator is at a predetermined height, such as the ceiling height of a trailer or at a height lower than the ceiling of the trailer to avoid contacting the trailer door frame. The height indicator 1902 can be used during loading to ensure that cargo loaded onto the mobile platform 102 or decks 104 does not exceed the height of the trailer. The height indicator 1902 is preferably installed by placing it into base 1904. The fit is such that the height indicators 1902 can be removed my hand but has enough retention to keep it from coming out due to accidental contact. Base 1904 has mating extension 1906 that engage with finger cutout 1908 (formed between post track 208 and table slot 206) and may be bolted into place or rest on finger cutout 1908.

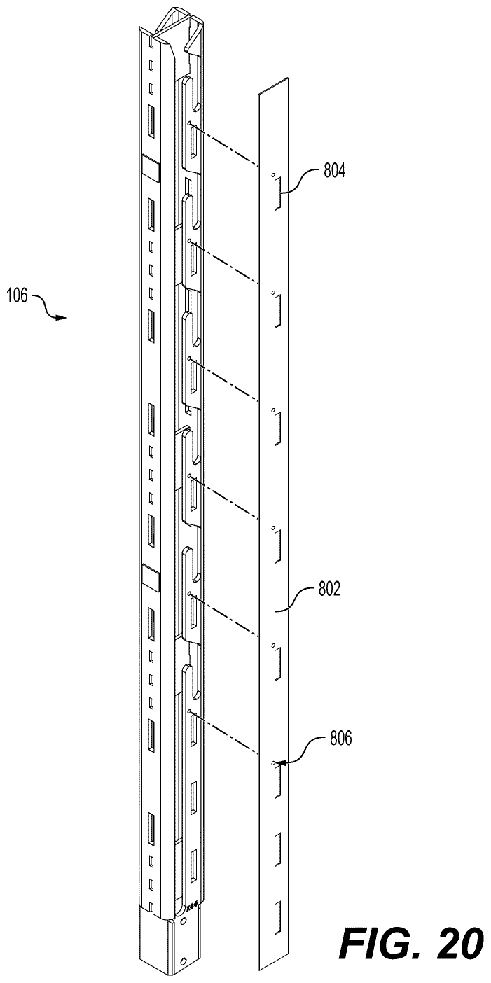

FIG. 20 depicts an end securement bracket 802 in isolation. The end securement bracket 802 is formed from a rectangular piece of material and has a plurality of openings 806 that align with openings 706 in vertical post 106. Screws or other fixing means can be used to couple end securement bracket 802 to vertical post 106 as depicted in FIG. 8. End securement bracket 802 has a plurality of openings 1804 that allow standard securement beams or straps to be installed past the edge of vertical post 106 to maximize cube utilization. Also, openings 804 may be used to secure base 1904 of height indicator 1902.

The mounting holes 706 are located on all vertical posts 106 and configured in a way that allows a single design for end securement bracket 802 to be installed on any vertical post 106. End securement bracket 802 may be formed from extrusion or laser cutting.

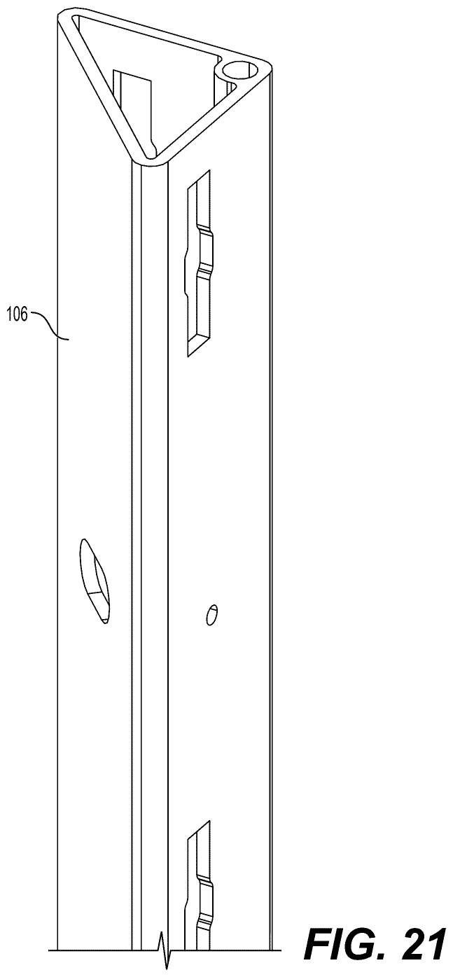

FIGS. 21 and 22 depict alternate embodiments for vertical posts 106. As depicted, the vertical posts 106 have a triangular cross section instead of a generally square or rectangular cross-section like other vertical posts. This type of vertical post 106 can be utilized at the end of a MP 102. The triangular cross section has a right angle and the two sides joined at the right angle can be used for the two interior edges of the MP 102. This would require the mounting location for the vertical post 106 to be changed, but this type of post is slightly lighter overall due to having a smaller cross-section.

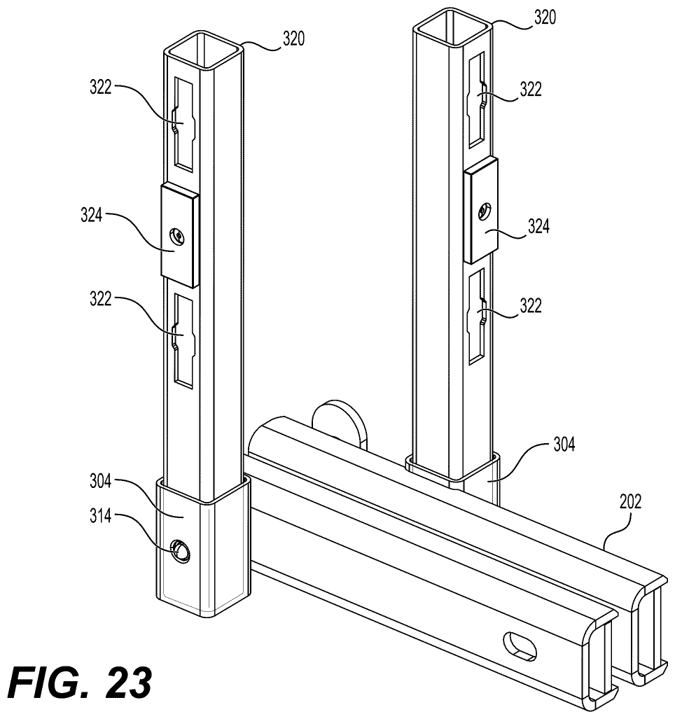

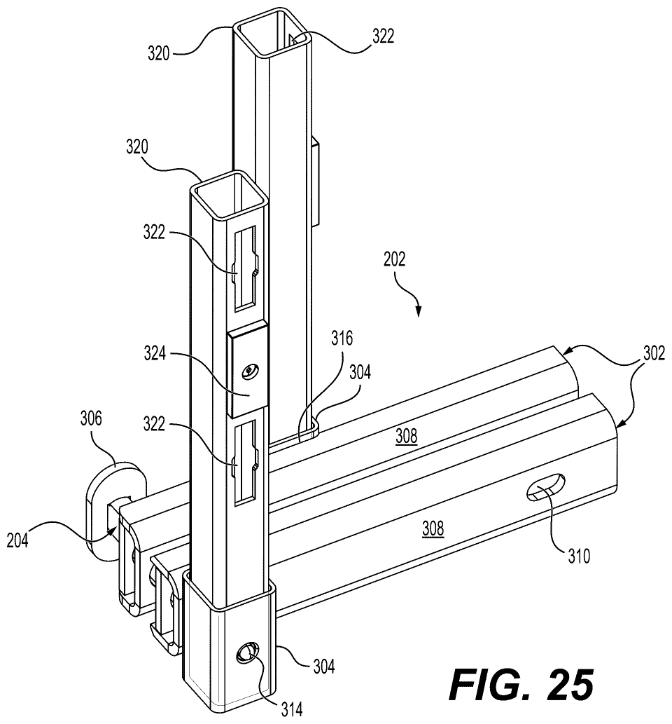

FIGS. 23-25 depict an embodiment of engagement members 202 having securement posts 320 inserted into securement beam mounts 304. A pin can be placed through opening 304 and a corresponding opening in engagement member 202 to secure the securement post 320 to the securement beam mount 304. Each of the securement posts 320 may have one or more openings 322 on at least one face that can be used for placing securement beams, tie downs, etc. In some embodiments, only one side of securement post 320 has openings 322 (e.g., for strength) whereas other embodiments may have multiple sides with openings 322 if more are required. A top of securement beam mount 304 is generally flush with a top surface of deck 104 so as not to interfere with items placed on deck 104. Securement posts are preferably removable (e.g., for oversized cargo), but they can also be permanently welded or attached in place. An optional magnet 324 is shown that can be used for storage when not in use to store out of the way to any steel structure.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

1. A modular decking system comprising:
a deck comprising:
a plurality of engagement members,
wherein each engagement member comprises a table pin with a retainer washer at a first end of the retainer washer; and
a plurality of vertical posts, wherein each vertical post comprises:
a vertical post track extending from a top of the vertical post a predetermined distance along a first side of the vertical post; and
a plurality of table slots located adjacent the vertical post track,
wherein each of the plurality of table slots has an opening to the vertical post track.

2. The modular decking system according to claim 1,
wherein the deck has a rectangular shape or a square shape.

3. The modular deck system according to claim 1,
wherein a width of the table pin is less than a horizontal width of the vertical post track, and
wherein a width of the retainer washer is greater than the horizontal width of the vertical post track.

4. The modular deck according to claim 1,
wherein a lower portion of each table slot is parallel to the vertical post track, and
wherein an upper portion of each table slot is angled downward and away from the vertical post track.

5. The modular deck according to claim 4, wherein the upper portion of teach table slot is open to the opening to the vertical post track.

6. The modular decking system according to claim 4,
wherein a width of the table pin is approximately the same as a width of the lower portion of each table slot such that the table pin can slide along a length of the lower portion of each table slot.

7. The modular decking system according to claim 1,
wherein a base of each vertical post is releasably coupled to a mobile platform using a locking pin.

8. The modular decking system according to claim 1,
wherein each engagement member is limited to movement in at least one dimension for a predetermined distance with respect to the deck.

9. The modular decking system according to claim 1, wherein each engagement member further comprises:
a first beam; and
a second beam coupled to the first beam,
wherein the table pin extends through an opening in the first beam, and
wherein a second end of the retainer washer is coupled to an interior surface of the second beam.

10. The modular decking system according to claim 9,
wherein the first beam and the second beam form a corner slide; and
wherein each corner of the deck comprises a corner pocket for receiving the corner slide.

11. The modular decking system according to claim 10,
wherein the corner slide comprises a first through hole,
wherein the pocket comprises a second through hole that aligns with the first through hole when the corner slide is received in the corner pocket, and
wherein an engagement pin inserted through the first through hole and the second through hole retains the engagement member within the corner pocket.

12. The modular decking system according to claim 10,
wherein a width of the engagement pin is approximately the same as a width of the second through hole, and
wherein the width of the engagement pin is less than a width of the first through hole.

13. The modular decking system according to claim 11,
wherein the first through hole has a circular shape, and
wherein the second through hole has an obround or oval shape.

14. The modular decking system according to claim 1, further comprising:
a mobile platform having a plurality of post openings for receiving the plurality of vertical posts,
wherein each vertical post comprises an angled base for angling each vertical post towards a center of the mobile platform when each vertical post is inserted into each post opening.

15. The modular decking system according to claim 1,
wherein a second side of the vertical post orthogonal to the first side comprises a plurality of E-track openings or securement beam openings.

16. The modular decking system according to claim 15,
wherein a third side of the vertical post opposite the first side comprises a second vertical post track.

17. The modular decking system according to claim 1, further comprising:
a deck installation funnel,
wherein a base of the deck installation funnel is configured to be removably inserted into a top opening of a vertical post of the plurality of vertical posts.

18. The modular decking system according to claim 1, wherein the base of the deck installation funnel comprises a cutout approximately a same size as an opening to the top opening of the vertical post track.

19. The modular decking system according to claim 18, wherein the deck installation funnel further comprises:
an angled ramp surface coupled to the base adjacent a first side of the cutout; and
a guide surface coupled to the angled ramp surface adjacent a second side of the cutout.

20. The modular decking system according to claim 19, wherein an edge of the guide surface is coupled to an edge of the angled ramp surface.
